(19) United States
(12) Patent Application Publication
(10) Pub. No.: US 2024/0011643 A1
(43) Pub. Date: Jan. 11, 2024

(54) COOKING TRAY AND COOKING APPLIANCE HAVING THE SAME

(71) Applicant: SAMSUNG ELECTRONICS CO., LTD., Suwon-si (KR)

(72) Inventor: Gyeongjin KIM, Suwon-si (KR)

(21) Appl. No.: 18/470,819

(22) Filed: Sep. 20, 2023

Related U.S. Application Data
(63) Continuation of application No. PCT/KR2022/095063, filed on Mar. 23, 2022.

(30) Foreign Application Priority Data
Mar. 31, 2021 (KR) 10-2021-0042342
Jul. 1, 2021 (KR) 10-2021-0086519

(51) Int. Cl. F24C 15/16; F24C 7/02; F24C 7/06

(52) U.S. Cl. CPC F24C 15/16; F24C 7/02; F24C 7/06

(57) ABSTRACT

A cooking apparatus includes a housing defining a cooking chamber, a tray retainer protruded from a side of the housing and toward the cooking chamber, a cooking tray which is insertable into the cooking chamber and detachably engageable with the housing at the tray retainer, the cooking tray including a plurality of cooking surfaces defined at a first surface of the cooking tray, and an interference member protruding from a second surface of the cooking tray which is opposite to the first surface, and a plurality of heaters which provide heats of different temperatures to the plurality of cooking surfaces of the cooking tray.

### CROSS-REFERENCE TO RELATED APPLICATIONS

This application is a continuation application of International Application No. PCT/KR2022/095063, designating the United States, filed on Mar. 23, 2022, at the Korean Intellectual Property Receiving Office and claiming priority to Korean Patent Application No. filed on Mar. 31, 2021 and Korean Patent Application No. 10-2021-0086519, filed on Jul. 1, 2021, at the Korean Intellectual Property Office, the disclosures of which are incorporated by reference herein in their entireties.

### BACKGROUND

### (1) Field

The present disclosure relates to a cooking apparatus. More particularly, the present disclosure relates to a cooking apparatus with an improved cooking tray.

### (2) Description of the Related Art

A cooking apparatus is a device for heating and cooking a cooking object, such as food. The cooking apparatus can provide various functions related to cooking, such as heating, defrosting, drying, and sterilizing the cooking object. Such cooking apparatus includes, for example, an oven, such as a gas oven or an electric oven, a microwave heating device (hereinafter referred to as a microwave), a gas range, an electric range, a gas grill, or an electric grill.

In general, an oven is an appliance that cooks food by transferring heat directly to the food through a heating source that generates heat, such as a heater, or by heating the inside of the cooking chamber. A microwave oven is a device that cooks food by using high-frequency radio waves as a heating source to disturb the molecular arrangement of food and generate intermolecular friction heat.

A cooking apparatus may be arranged to perform the functions of both an oven and a microwave oven. Specifically, a heater may be disposed on one side of the cooking chamber and a magnetron may be disposed on another side opposite to the one side, to heat the food in different ways.

Further, there may be a plurality of such heaters. Thus, a tray mounted within the cooking chamber may be arranged to include a plurality of cooking surfaces that are heated to different temperatures by the plurality of heaters.

However, if the user inserts the tray inside the cooking chamber in the wrong way, the cooking surface will be reversed and the food will not be able to cook to the desired temperature.

Also, if the user places the tray upside down on the floor of the cooking chamber, the high frequency generated by the lower magnetron may collide with the top surface of the tray, causing a spark.

### SUMMARY

A tray mountable within the cooking chamber may include a plurality of cooking surfaces that are heatable to different temperatures by respective heater among a plurality of heaters of a cooking appliance. However, if the tray is inserted inside the cooking chamber of the cooking appliance in the wrong orientation, the cooking surface will be reversed and the food will not be able to cook to the desired temperature. Also, if the tray is placed upside down on the floor of the cooking chamber of the cooking appliance, the high frequency generated by the lower magnetron may collide with the top surface of the tray causing a spark.

Therefore, it is an aspect of the disclosure to provide a cooking apparatus with a structure that prevents the tray from being inserted into the cooking chamber in a reverse direction.

It is another aspect of the disclosure to provide a cooking apparatus in which a safety accident is prevented even when the tray is placed upside down on the bottom surface of floor of the cooking chamber.

It is an aspect of the disclosure to provide a cooking apparatus in which no screw engagement structure is formed in the tray.

In accordance with an aspect of the disclosure, a cooking apparatus includes a cavity forming a cooking chamber, a plurality of heaters arranged on an upper side of the cavity for heating a cooking object, a tray including a plurality of cooking areas configured for the cooking object to be arranged on the plurality of cooking areas and to which heat is transferred by the plurality of the heaters with different temperatures, a tray retainer formed on a side of the cavity and configured to detachably engage the tray and an interference member protruding downwardly from a bottom surface of the tray.

The interference member is formed at the rear of the tray with respective to a direction in which the tray is inserted into the cooking chamber and is arranged to cover a portion of a front of the tray retainer.

The tray includes a plate with a cooking surface and where cooking is performed and a tray holder mounted on a side portion of the plate, where the tray holder arranged to abut the tray retainer to support the plate.

The tray holder includes a support surface configured to be supported on the tray retainer and on which the interference member is formed and where the tray retainer includes a holder fastening surface on which the tray holder rests.

The interference member extends from the support surface of the tray holder to a position lower than the holder fastening surface of the tray retainer.

The interference member is configured to interfere with the tray retainer when the tray is reversely inserted into the cooking chamber.

The plate includes a cooking portion on which cooking is performed and an edge part provided on a rim of the cooking portion and in which a locking groove is formed for insertion of the tray holder.

The tray holder includes a locking protrusion formed on an inner upper surface of the tray holder to be inserted into the locking groove.

The tray holder includes a material different from the plate.

The tray retainer below the tray arranged to support the lower portion of the tray and where the cooking apparatus further includes a tray supporter on an upper portion of the tray arranged to prevent upward flow of the tray resting on the tray retainer.

The tray further includes a plurality of separation members protruding upwardly from an upper surface of the tray.

The tray includes a plate including the plurality of cooking surfaces, a tray holder mounted on a side portion of the plate and the plurality of separation members extend upwardly from an upper surface of the tray holder.

A extension height of the plurality of separation members with respect to the upper surface of the plate is provided at 8 millimeters (mm) or more.

The plurality of separation members are formed on an inner side of the tray holder than the interference member.

The cooking apparatus further includes a magnetron disposed in a lower portion of the cooking chamber and the bottom surface of the tray includes a material that absorbs high frequencies generated by the magnetron.

In accordance with another aspect of the disclosure, a cooking apparatus includes a cavity including a cooking chamber in which a tray retainer is formed, and a tray supported on the tray retainer and inserted in to the cooking chamber with a rear side facing the cooking chamber, the tray including a plate on which cooking is performed, a tray holder mounted on a side portion of the plate to support the plate and resting on the tray retainer, and an interference member formed on a lower portion of the tray holder to interfere with the tray retainer and prevent insertion of the tray when the tray is inserted with a front side facing the cooking chamber.

The tray includes a plurality of separation members extending upwardly from an upper surface of the tray holder, the separation members being formed on an inner side of the tray holder than the interference member.

The plate includes a locking groove formed on its upper surface and the tray holder including a locking protrusion inserted into the locking groove.

In accordance with another aspect of the disclosure, a cooking apparatus includes a cavity including a cooking chamber, a first tray retainer projecting toward the cooking chamber from a first side of the cooking chamber, a second tray retainer projecting toward the cooking chamber from a second side opposite the first side of the cooking chamber, and a plate including a plurality of cooking areas to which heat of different temperatures is transferred, a first tray holder mounted on one side of the plate and supported by the first tray retainer, a second tray holder mounted on a different side of the plate and supported by the second tray retainer, and an interference member formed on a lower portion of the first tray holder so as to interfere with the second tray retainer when the first tray holder is inserted into the cooking chamber toward the second tray retainer.

The first tray holder includes a separation member extending upwardly from an upper surface of the first tray holder and formed on an inner side of the first tray holder than the interference member.

The cooking apparatus of the present invention prevents the tray from being inserted into the cooking chamber in the wrong direction, the cooking can be performed as intended by the user.

It is possible to prevent accidents and malfunctions by forming a space where high frequencies can be emitted by the separation member even if the magnetron is operated while the tray is placed upside down on the bottom of the cooking chamber.

There is an effect of avoiding the problem caused by high frequencies by joining the tray holder and the plate with a grooved structure without any fasteners.

### BRIEF DESCRIPTION OF THE DRAWINGS

The above and other advantages and features of this disclosure will become more apparent by describing in further detail embodiments thereof with reference to the accompanying drawings, in which:

FIG. 1 is a perspective view of a cooking apparatus according to an embodiment of the present invention,

FIG. 2 illustrates a partial configuration of an interior of a cooking apparatus according to an embodiment of the present invention,

FIG. 3 is a cross-sectional view of a cooking apparatus according to an embodiment of the present invention,

FIG. 4 is a top perspective view of a tray of a cooking apparatus according to an embodiment of the present invention,

FIG. 5 is a bottom perspective view of the tray in FIG. 4,

FIG. 6 is an exploded perspective view of the tray in FIG. 4,

FIG. 7 is a bottom perspective view of a tray holder of FIG. 6,

FIG. 8 is a cross-sectional side view of the tray in FIG. 4,

FIG. 9 is an enlarged front view of portion E of a tray in FIG. 4,

FIG. 10 is an enlarged view of portion F of FIG. 3,

FIG. 11 is an enlarged front view of a tray of a cooking apparatus resting in a tray retainer according to an embodiment of the present invention,

FIG. 12 is an enlarged view of a tray of a cooking apparatus lying face down on a bottom surface according to an embodiment of the present invention, and

FIG. 13 is a cross-sectional view of the coupling of a plate and a tray holder of a cooking apparatus according to an embodiment of the present invention.

### DETAILED DESCRIPTION

Embodiments described in the disclosure and configurations shown in the drawings are merely examples of the embodiments of the disclosure, and may be modified in various different ways at the time of filing of the present application to replace the embodiments and drawings of the disclosure.

In addition, the same reference numerals or signs shown in the drawings of the disclosure indicate elements or components performing substantially the same function.

Also, the terms used herein are used to describe the embodiments and are not intended to limit and/or restrict the disclosure. The singular forms “a,” “an” and “the” are intended to include the plural forms as well, unless the context clearly indicates otherwise. In this disclosure, the terms “including”, “having”, and the like are used to specify features, numbers, steps, operations, elements, components, or combinations thereof, but do not preclude the presence or addition of one or more of the features, elements, steps, operations, elements, components, or combinations thereof.

It will be understood that when an element is referred to as being related to another element such as being “on” another element, it can be directly on the other element or intervening elements may be present therebetween. In contrast, when an element is referred to as being related to another element such as being “directly on” another element, there are no intervening elements present.

It will be understood that, although the terms first, second, third, etc., may be used herein to describe various elements, but elements are not limited by these terms. These terms are only used to distinguish one element from another element. For example, without departing from the scope of the disclosure, a first element may be termed as a second element, and a second element may be termed as a first element.

The term of “and/or” includes a plurality of combinations of relevant items or any one item among a plurality of relevant items.

In the following detailed description, the terms of “front”, “rear”, “left”, “right”, and the like may be defined by the drawings, but the shape and the location of the component is not limited by the term.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±30%, 20%, 10% or 5% of the stated value.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

Hereinafter, embodiments according to the present invention will be described in detail with reference to the accompanying drawings.

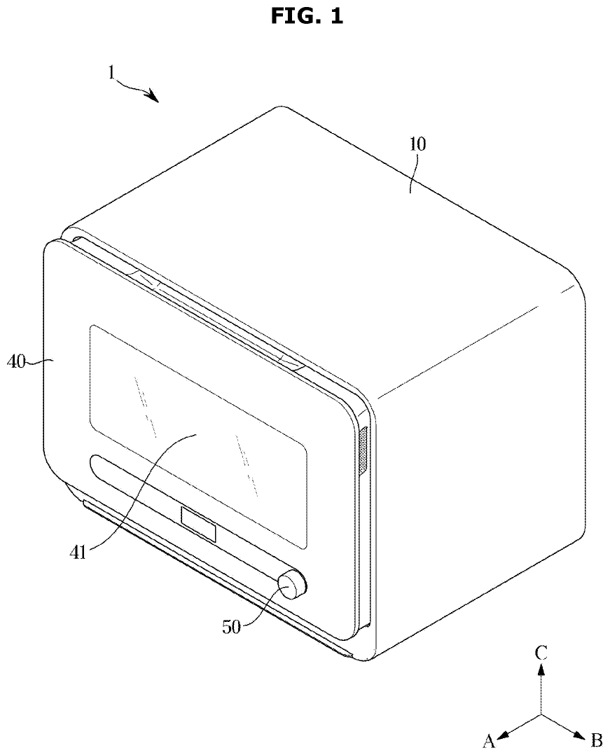

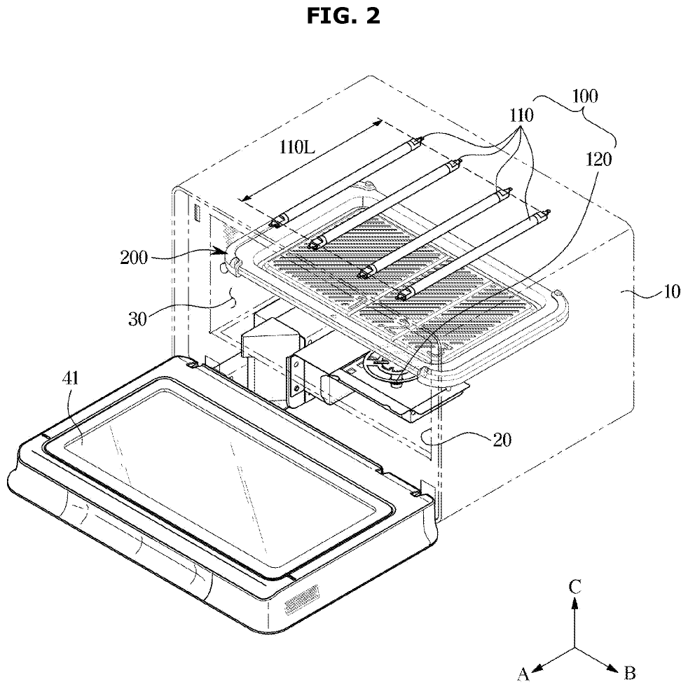

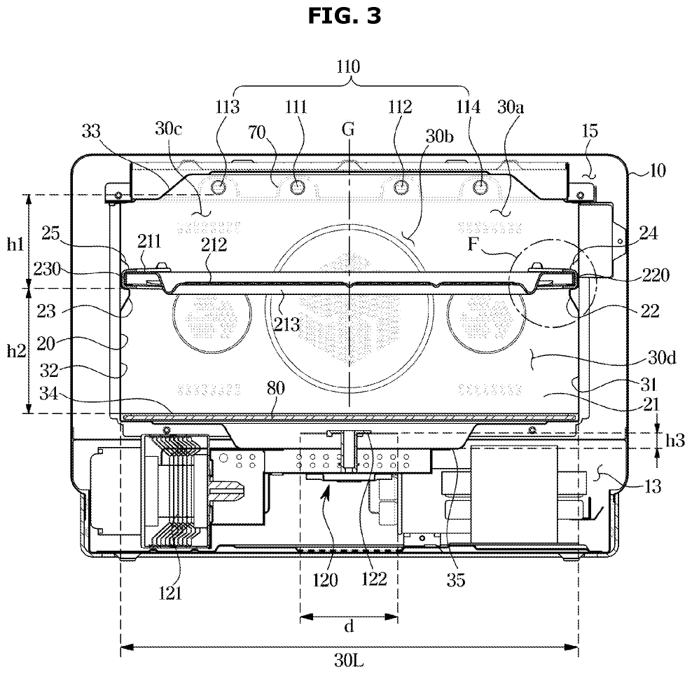

FIG. 1 is a perspective view of a cooking apparatus 1 according to an embodiment of the present invention. FIG. 2 illustrates a partial interior configuration of a cooking apparatus 1 according to an embodiment of the present invention. FIG. 3 is a cross-sectional view of a cooking apparatus 1 according to an embodiment of the present invention.

As shown in FIGS. 1 to 3, a cooking apparatus 1 may include a housing 10 forming an exterior of the cooking apparatus 1, and a cooking chamber 30 arranged inside the housing 10 and in which a cooking object may be located.

The cooking apparatus 1 may include a cavity 20 disposed inside a housing and forming the cooking chamber 30. The housing 10 may define an outer housing and the structures of the cavity 20 may define an inner housing which is inside of a spaced apart from the outer housing. A predetermined spacing 15 may be formed between the cavity 20 and the housing 10, that is, the between the inner housing and the outer housing 10.

The housing 10 and the cavity 20 may each be arranged to be open in a first direction A, which is a forward direction or a front direction of the cooking apparatus 1. A insertion direction of the cooking apparatus 1 is a direction opposite to the first direction A. That is, a cooking tray is insertable into and removable from the cavity 20 along the insertion direction.

The cooking object may be positioned in the cooking chamber 30, such as by a user, through an opening 21 of the cavity 20 formed to be open in the first direction A.

The cooking chamber 30 may be arranged in a roughly cuboidal shape with a long side 30L in a second direction B crossing the first direction A. In an embodiment, the second direction B may be orthogonal to the first direction A.

The cooking apparatus 1 may include a door 40 arranged to open and close the opening 21 in the housing 10 and the cavity 20. The door 40 which is open may expose the cooking chamber 30 to outside the cooking apparatus 1, while the door 40 which is closed may separate the cooking chamber 30 from outside the cooking apparatus 1.

The door 40 may include an input device 50 for inputting signals from outside the cooking apparatus, such as from a user, to control operation of the cooking apparatus 1. However, the input device 50 may not be limited to the form shown in FIG. 1. For example, the input device 50 may include a display unit (not shown) that displays an image, or a touching part (not shown) that is arranged to input a signal by touching the image. Although not shown, the cooking apparatus 1 may further include a controller such as a processor, a computer, etc. for controlling operation of the cooking apparatus 1, such as simultaneous cooking at upper and lower portions of the cooking chamber 30, without being limited thereto. The controller may use the inputs from the input device 50 to control operation of the cooking apparatus 1.

The door 40 may include a transparent portion 41 arranged to allow the user to observe the interior of the cooking chamber 30 when the door 40 is closed. That is, the door 40 which is closed disposes the interior of the cooking chamber 30 viewable from outside the cooking apparatus 1, by the transparent portion 41.

The cooking apparatus 1 may include a tray 200 mountable inside the cooking chamber 30 and arrangeable for a user to position a cooking object. The tray 200 may be removably disposed within the cooking chamber 30. The tray 200 may be arranged to be withdrawn from the cooking chamber 30, through a front of the cooking chamber 30 (e.g., in the first direction A).

The cooking chamber 30 may include a plurality of tray retainers 22 and 23 formed or provided at each side of the cooking chamber 30. That is, the tray retainers 22 and 23 may be in the cooking chamber 30. The tray 200 is mountable between an upper surface 33 and a bottom surface 34 of the cooking chamber 30.

Further, the cooking chamber 30 may include a plurality of tray supporters 24 and 25. That is, the plurality of tray supporters 24 and 25 may be in the cooking chamber 30. Further, a plurality of tray retainers 22 and 23 and a plurality of tray supporters 24 and 25 may be formed at different heights relative to each other. This will be described in more detail later.

The tray 200 may include a plurality of cooking surfaces 2121, 2122 and 2123 on which the cooking object may be positioned. A plurality of cooking surfaces 2121, 2122 and 2123 may be arranged to face an upper surface 33 of the cooking chamber 30 when the tray 200 is mounted inside the cooking chamber 30. That is, the cooking apparatus 1 having the tray 200 in the cooking chamber 30 (or the tray 200 which is mounted in the cooking chamber 30) includes the plurality of cooking surfaces 2121, 2122 and 2123 arranged to face the upper surface 33 of the cooking chamber 30.

The cooking apparatus 1 may include a plurality of heating sources 100 that provide heat to the interior of the cooking chamber 30 such that the cooking object is cookable by the provided heat.

A plurality of heating sources 100 may be arranged to provide heat to the cooking object located on the tray 200, so that the cooking object may be cooked. Additionally, the cooking object may be positioned on the bottom surface 34 (e.g., the lower surface) of the cooking chamber 30 without the tray 200. In this case, a plurality of heating sources 100 may still provide heat to the cooking object located on the bottom surface 34.

A plurality of heating sources 100 may include a first heating source 110 disposed on an upper surface 33 of the cooking chamber 30.

The plurality of heating sources 100 may include a second heating source 120 disposed in a lower portion of the cooking chamber 30. That is, the second heating source 120 may be closer to the bottom surface 34 than the first heating source 110.

The first heating source 110 may include a plurality of heaters 111, 112, 113 and 114 that generate radiant heat. A plurality of heaters 111, 112, 113 and 114 may radiate heat generated by themselves and transfer heat directly to the cooking object. A plurality of heaters 111, 112, 113 and 114 may be mounted on a top side of the inner housing (e.g., the cavity 20). A plurality of heaters 111, 112, 113 and 114 may be disposed on the upper side of the cavity 20 for heating the cooking object. That is, the first heating source 110 may be further from the bottom surface 34 than the second heating source 120. In an embodiment, the plurality of heaters 111, 112, 113 and 114 may be coplanar with each other, such as to all be disposed in a same plane defined by the first direction A and the second direction B crossing each other.

The second heating source 120 may include a magnetron 121 that generates a high frequency. The high frequency generated by the magnetron 121 may be injected into the interior of the cooking object. The high frequency may be arranged to cook the interior of the cooking object by frictional heat between the molecules generated by repeatedly converting the molecular arrangement of the moisture contained in the cooking object.

The magnetron 121 may be disposed in a machine room 13. The machine room 13 may be a space within the cooking apparatus 1 which has a volume, and the magnetron 121 is disposed in such volume. The machine room 13 may be under the cooking chamber 30 and separated from the cooking chamber 30 by the bottom surface 34. The second heating source 120 may oscillate a high frequency from the machine room 13 toward the bottom surface 34 of the cooking chamber 30, along a third direction C, and the high frequency may pass through the bottom surface 34 to be irradiated into the tray 200.

Thus, the cooking apparatus 1 according to an embodiment of the present invention may be arranged so that cooking of the cooking object proceeds efficiently, by including the first heating source 110 together with the second heating source 120.

The first heating source 110 is disposed on the upper surface 33 of the cooking chamber 30 as described above, such that radiant heat can be efficiently transferred to the upper side of the cooking object. However, it may be difficult to transfer the radiant heat to the lower side of the cooking object.

At this time, in order for additional heat to be transferred to the underside of the cooking object, the user may be inconvenienced by having to stop the operation of the cooking apparatus 1 while it is in operation, withdraw the shelf from the cooking chamber turn the cooking object over, insert it back into the cooking chamber 30, and restart the cooking apparatus 1.

However, the cooking apparatus 1 according to an embodiment of the present invention may include a heat generator 213 arranged in the tray 200 such that heat is also transferred to the underside of the cooking object during cooking.

The heat generator 213 as a heat generating layer may be disposed on a side of the tray 200 which is opposite to the surface at which a plurality of cooking surfaces 2121, 2122 and 2123 is arranged. The heat generator 213 may be arranged to face a bottom surface 34 of the cooking chamber 30 when the tray 200 is mounted in the cooking chamber 30.

The heat generator 213 may be heatable by absorbing high frequencies generated by the magnetron 121 and transferred to the heat generator 213. The high frequency irradiated from the magnetron 121 facing the heat generator 213 is absorbed by the heat generator 213, and the heat generator 213 can generate heat by the absorbed high frequency.

Heat generated by the heat generator 213 can be transferred to a plurality of cooking surfaces 2121, 2122 and 2123 via the cooking surface 212 of the tray 200. The cooking surface 212 of the tray 200 may be a cooking surface 212 including the plurality of cooking surfaces 2121, 2122 and 2123 together with each other. The plurality of cooking surfaces 2121, 2122 and 2123 may respectively be planar areas of such cooking surface (or planar areas of the tray 200 itself).

That is, heat generated by the heat generator 213 may be conducted to a plurality of cooking surfaces 2121, 2122 and 2123 to provide heat to the underside of the cooking object which is located on the plurality of cooking surfaces 2121, 2122 and 2123.

The heat generator 213 may be formed of a ferrite material to absorb high frequencies. However, without limitation, a material capable of being heated by high frequency may be mixed with a ceramic or the like to form the heat generator 213.

The heat generator 213 which absorbs high frequencies together with the radiant heat generators allows heat to be supplied to both the top and bottom of the cooking object without having to turn the cooking object over, allowing for efficient cooking.

The tray 200 which is mounted in the cooking chamber 30 may compartmentalize an interior region of the cooking chamber 30.

The tray 200 may compartmentalize the interior of the cooking chamber 30 in an upward and downward direction (e.g., along the third direction C as a thickness direction of the cooking apparatus 1) into a first cooking area 30a (or first cooking volume), a second cooking area 30b (or a second cooking volume), a third cooking area 30c (e.g., a third cooking volume) formed or provided on an upper side of the tray 200 mounted in the cooking chamber 30, together with a fourth cooking area 30d (e.g., a fourth cooking volume) formed on a lower side of the tray 200 mounted in the cooking chamber 30. In other words, the cooking chamber 30 in which the tray 200 is mounted may include a plurality of cooking areas 30a, 30b, 30c and 30d each configured to receive the cooking object, where the cooking areas are provided with heat of different temperatures by a plurality of heaters 111, 112, 113 and 114. That is, the plurality of radiant heaters provides different temperatures across the cooking surface 212 of the tray 20, where the different temperatures correspond to (or define) the various cooking areas described above.

The first cooking area 30a, the second cooking area 30b, and the third cooking area 30c as a cooking area of the cooking chamber 30 may be arranged along the second direction B, such that the cooking object cooked by the first heating source 110 and the second heating source 120 is received in the cooking area. That is, the cooking object placed in the cooking area including the first cooking area 30a, the second cooking area and the third cooking area 30c together with each other, may be cooked by heat generated by a plurality of heaters 111, 112, 113 and 114 together with the heat generator 213.

The fourth cooking area 30d may be arranged so that the cooking object that is cooked by the second heating source 120 is disposed therein. The cooking object disposed in the fourth cooking area 30d may be cooked by a high frequency generated by the second heating source 120.

The interior of the cooking chamber 30 is compartmentalized by the tray 200 into an upper cooking area as one or more among the first cooking area 30a, the second cooking area 30b, and the third cooking area 30c, and a lower cooking area (e.g., the fourth cooking area 30d), so that more than one cooking object having different cooking methods can be placed inside the cooking chamber 30 and simultaneously cooked in a same one of the cooking chamber 30.

In other words, even if one or more of a first cooking object cooked by external heat (e.g., such as radiant heat) is placed in the first cooking area 30a, second cooking area and/or third cooking area 30c, and a second cooking object cooked by internal heat (e.g., such as by application of high frequency) in the fourth cooking area 30d, the first heating source 110 and the second heating source 120 can be operated simultaneously to cook each cooking object simultaneously.

Accordingly, respective cooking objects cooked by different cooking methods can be cooked in the same one of the cooking chamber 30 at a same time, thereby increasing user convenience of the cooking apparatus 1.

As will be described later, the area (e.g., a planar area) of the tray 200 may be formed to correspond to the area (e.g., the planar area) of the cooking chamber 30. Accordingly, heat generated by the first heating source 110 in the first cooking area 30a, second cooking area 30b, and third cooking area 30c may be partially blocked from being transferred to the fourth cooking area 30d.

In addition, high frequencies generated in the fourth cooking area 30d may be partially blocked from traveling to the first cooking area 30a, second cooking area 30b, and third cooking area 30c.

Thus, independent cooking may be respectively performed in the upper cooking area as including the first cooking area 30a, the second cooking area 30b and the third cooking area 30c, and the lower cooking area as including the fourth cooking area 30d.

When a plurality of heaters 111, 112, 113 and 114 are disposed arranged along the upper surface 33 of the cooking chamber 30, as in an embodiment of the present invention, heat may be provided inside the cooking chamber 30 at respective locations corresponding to each of the heaters, in the third direction C. The heat provide a respective radiant heater has a temperature. The temperatures respectively provided by the radiant heaters may be the same as each other or different from each other.

More specifically, a plurality of cooking surfaces 2121, 2122 and 2123 of the tray 200 may be regions that are provided with different temperatures. That is, within the upper cooking area, the heat and/or the temperature of the heat provided to the various cooking surfaces may be different from each other.

On a plurality of cooking surfaces 2121, 2122 and 2123, a plurality of cooking areas 30a, 30b and 30c may be formed or provided. The plurality of cooking areas 30a, 30b and 30c and/or the plurality of cooking surfaces 2121, 2122 and 2123 may be arranged at positions corresponding to the respective heaters, in the third direction C. Each of the cooking areas 30a, 30b and 30c may be arranged to directly transfer heat generated by the respective heater, to a respective cooking surface among the plurality of cooking surfaces 2121, 2122 and 2123.

Accordingly, even if a plurality of cooking objects with different cooking temperatures are simultaneously placed in the upper cooking area of the cooking chamber 30, each cooking object may be cooked according to a different cooking temperature since the cooking objects are respectively placed on a plurality of cooking areas 30a, 30b and 30c corresponding to the plurality of cooking surfaces 2121, 2122 and 2123 that are compartmentalized or defined by different temperatures. In an embodiment, if a user places different cooking objects in different cooking areas, each cooking object can be cooked to a different temperature.

The cooking chamber 30 is arranged in a cuboidal shape with a long side 30L extending in the second direction B and a short side extending in the first direction A. The tray 200 which corresponds to the cooking chamber 30 having the long side 30L may also include a planar cooking surface in a rectangular shape with a long side 30L in the second direction B together with a short side in the first direction A. The cooking chamber 30 is arranged in the shape of a cube.

Each of the plurality of heaters 111, 112, 113 and 114 may include a long axis 110L extending in the first direction A. The plurality of heaters 111, 112, 113 and 114 may be arranged spaced apart from each other in the second direction B which intersects the first direction A and the third direction C and corresponds to a direction of extension of the long side 30L of the cooking chamber 30 (e.g., an extension direction).

Accordingly, on a plurality of cooking surfaces 2121, 2122 and 2123 of the tray 200, a plurality of cooking areas 30a, 30b and 30c that are provided with different temperatures of heat may be divided or compartmentalized along the second direction B.

The following describes in detail a plurality of heaters 111, 112, 113 and 114 and a plurality of cooking areas 30a, 30b and 30c that are divided along a length of the tray 200 according to one embodiment of the present invention.

The plurality of heaters 111, 112, 113 and 114 may include four heaters, such as a first heater 111, a second heater 112, a third heater 113, and a fourth heater 114. However, the number of heaters is not limited thereto and may include only the first heater 111 and the second heater 112, or may include a greater number of heaters than four heaters.

The first heater 111 may be disposed on one side of the cooking apparatus 1 (e.g., a first side) in or along the second direction B, and the second heater 112 may be disposed on the opposite side of the first heater 111 along the second direction B (e.g., a second side).

The cooking chamber 30 may have a center line G defined along the second direction B. In detail, the first heater 111 may be disposed on one side and the second heater 112 may be disposed on the opposite side of the cooking surface 212 relative to the center line G of the cooking surface, with respect to the second direction (B). The third heater 113 may be disposed on one side adjacent to the first heater 111, and the fourth heater 114 may be disposed on the opposite side adjacent to the second heater 112. Referring to FIG. 3, for example, the third heater 113, the first heater 111, the center line G, the second heater 112 and the fourth heater 114 may be in order along the length of the tray 200.

The first heater 111 and the third heater 113 may generate heat having a temperature, and the temperature of the first heater 111 and the third heater 113 may be the same as each other. Further, the second heater 112 and the fourth heater 114 may generate heat of the same temperature as each other in similar fashion.

A first group of heaters as including the first heater 111 and the third heater 113, and a second group of heaters as including the second heater 112 and the fourth heater 114, may be arranged to deliver different temperatures of heat. That is, the heating temperature delivered on one side of the center line G (e.g., a first heating temperature) and the heating temperature delivered on the other side of the center line G (e.g., a second heating temperature) may be different from each other.

The temperature of the heat generated by a plurality of heaters 111, 112, 113 and 114 may be the same for all of the radiant heaters. While the cooking apparatus 1 is being operated, the cooking apparatus 1 may control the a plurality of heaters 111, 112, 113 and 114 such that the first heater 111 and the third heater 113 are operated continuously, and the second heater 112 and the fourth heater 114 are operated with repeated on/off to be driven cyclically. That is, the plurality of radiant heaters may be independently controlled or groupedly controlled, for achieving various heating temperatures across the cooking surface 212 of the tray 200.

Conversely, a plurality of heaters 111, 112, 113 and 114 may be controlled such that the first heater 111 and the third heater 113 are driven in a cycle of on/off, while the second heater 112 and the fourth heater 114 are driven continuously.

Accordingly, a total temperature of the heat generated by the first heater 111 and the third heater 113 as a sum of individual heating temperatures thereof may be different from a total temperature of the heat generated by the second heater 112 and the fourth heater 114 as a sum of individual heating temperatures thereof.

However, without limitation, in an embodiment, the temperatures generated by the first heater 111 and the third heater 113 may be different from the temperatures generated by the second heater 112 and the fourth heater 114.

A plurality of heaters 111, 112, 113 and 114 of the cooking apparatus 1 according to an embodiment of the present invention are spaced apart along the second direction B, so that the first cooking surface 2121, the second cooking surface 2122, and the third cooking surface 2123 may be compartmentalized in the second direction B.

The first cooking area 30a, the second cooking area 30b, and the third cooking area 30c may be divided into cooking areas along the second direction B to which different cooking temperatures may be variously applied by the first heater 111 and the third heater 113 and the second heater 112 and the fourth heater 114.

In detail, the third cooking area 30c may be arranged in an area (e.g., a planar area) corresponding to the first heater 111 and the third heater 113, and the second cooking area 30b and the first cooking area 30a may be arranged in an area (e.g., a planar area corresponding to the second heater 112 and the fourth heater 114.

The third cooking area 30c may be arranged to correspond to the first cooking surface 2121 of the tray 200, the second cooking area 30b may be arranged to correspond to the second cooking surface 2122 of the tray 200, and the first cooking area 30a may be arranged to correspond to the third cooking surface 2123 of the tray 200.

Accordingly, a different plurality of cooking objects in different cooking areas among the first cooking area 30a, the second cooking area 30b, and the third cooking area may be simultaneously cooked in the upper cooking area. Furthermore, the cooking object may be simultaneously cooked in the fourth cooking area 30d as a lower cooking area.

When the cooking object cooked in the first cooking area 30a is referred to as the first cooking object, the cooking object cooked in the second cooking area 30b is referred to as the second cooking object, the cooking object cooked in the third cooking area 30c is referred to as the third cooking object, and the cooking object cooked in the fourth cooking area 30d is referred to as the fourth cooking object, the first, second, third, and fourth cooking objects may be cooked by different external temperatures and/or high frequencies, respectively.

That is, cooking objects having different cooking methods or different cooking temperatures may be simultaneously cooked inside a single cooking chamber 30.

However, without limitation, a greater number of different cooking methods or cooking objects with different cooking temperatures may be cooked simultaneously.

The tray 200 may be disposed to be adjacent to (e.g., closer to) the first heating source 110 than the second heating source 120 along the third direction C, which is an up-down direction or a thickness direction.

That is, a first distance h1 from the cooking surface 212 to a layer or plane in which the plurality of heaters 111, 112, 113 and 114 are disposed may be formed to be shorter than a second distance h2 from the cooking surface 212 to the bottom surface 34 of the cooking chamber 30. The tray 200 being at a smaller distance from the radiant heaters than to the second heating source 120 more efficiently compartmentalizes the first cooking area 30a, the second cooking area 30b, and the third cooking area 30c along the upper cooking area.

The cooking apparatus 1 may include a reflective member 70 arranged to reflectively transmit heat generated by the first heater 111 and the third heater 113 in the third direction C, to the first cooking area 30a in a direction opposite to the third direction C. The reflective member 70 further reflectively transmits heat generated by the second heater 112 and the fourth heater 114 in the third direction C, to the second cooking area and the third cooking area 30c respectively, in the direction opposite to the third direction C.

The reflective member 70 may be disposed on a top side of the plurality of heaters 111, 112, 113 and 114, that is, in the third direction C. The reflective member 70 may be shaped to wrap around the upper side of each of the heaters in the third direction C. Accordingly, the heat generated by each of a plurality of heaters 111, 112, 113 and 114 may be concentrated in the lower part. Referring to FIG. 3, for example, the reflective member 70 may define a recess or concave portion in which a respective radiant heater is disposed. The concave portion may be open to the cooking chamber 30 and extend along a length of the respective radiant heater in the first direction A. Concave and convex portions are alternately arranged along the second direction B. Since the concavo-convex cross-sectional shape of reflective member 70 extends along a cross-sectional shape of the radiant heaters, the heat generated by each of a plurality of heaters 111, 112, 113 and 114 may be concentrated at a lower part of the reflective member 70 which is closest to the tray 200.

The second heating source 120 may include a stirrer 122 arranged to mix the high frequencies emitted by the magnetron 121 and radiate the high frequencies uniformly into the cooking chamber 30.

Referring to FIG. 2, for example, the stirrer 122 of the second heating source 120 may be have a circular shape. Referring to FIG. 3, a circular body of the stirrer 122 may be rotatable about a rotation axis. An incision or enclosed opening may be defined in the circular body of the stirrer 122. Accordingly, rotation of the stirrer 122 radiates high frequencies directed only to one side of the cooking chamber 30 in various directions to reach the entirety of the interior of the cooking chamber 30.

The stirrer 122 may be arranged so that a third distance h3 between the circular body of the stirrer 122 and an installation surface 35 at which the stirrer 122 is installed, in the third direction C has a predetermined length. In an embodiment, when the capacity or volume of the cooking chamber 30 is arranged to be approximately 20 liters (L) to approximately 30 L, the third distance h3 from the installation surface 35 to the circular body of the stirrer 122 may be arranged to be approximately 30 millimeters (mm) or less.

A glass member 80 may be disposed on the bottom side of the cavity 20 to cover the top of the stirrer 122. The glass member 80 may form or define the bottom surface 34 of the cooking chamber 30. The cooking object may be secured to the glass member 80 and cooking may be performed in the fourth cooking area 30d.

Referring to FIG. 3, the tray retainers 22 23 may include a first tray retainer 22 and a second tray retainer 23.

The first tray retainer 22 may be arranged to project toward the cooking chamber 30 from a first side surface 31 of the cooking chamber 30. The second tray retainer 23 may be arranged to project toward the cooking chamber 30 from a second side surface 32 of the cooking chamber 30. In an embodiment, referring to FIG. 3, the cavity 20 as an inner housing may be include the first side surface 31, the second side surface 32 and the upper surface 33. In an embodiment, the cavity 20 may further include a lower surface which is under the glass member 80 and extends along the glass member 80 and a back surface which connects each of the first side surface 31, the second side surface 32, the upper surface 33 and the lower surface to each other to define the cooking chamber 30 open in the first direction A.

The first tray retainer 22 and the second tray retainer 23 may be arranged to protrude inwardly from a respective side surface of the cavity 20. More specifically, the tray retainer may be formed by being recessed from an outer side of the cavity 20 inwardly. In an embodiment, a tray retainer may be a protruded portion of the inner housing (e.g., the cavity 20) to define a recess in which the tray 200 is accommodated. The side surface of the cavity 20 may protrude to define the tray retaining, without being limited thereto.

The cooking apparatus 1 may include a tray supporter arranged at an upper portion of the tray retainer, such as to face a respective tray retainer. The tray supporter may be arranged to prevent upward movement of the tray 200 mounted on the tray retainer. The tray supporters 24 and 25 may include a first tray supporter 24 and a second tray supporter 25.

The first tray supporter 24 may be provided on top of and facing the first tray retainer 22 along the thickness direction to be disposed along a same line extended along the first direction A. The first tray supporter 24 may be arranged to project from the first side surface 31 (or be a projection of the first side surface 31) of the cavity 20 toward the cooking chamber 30. That is, The first tray supporter 24 may be arranged to project inwardly from a sidewall of the cavity 20, and may form a depression in a direction from an outer side of the cavity 20 to an inner side.

The second tray supporter 25 may be arranged on top of and facing the second tray retainer 23 along the thickness direction along the thickness direction to be disposed along a same line extended along the first direction A. The second tray supporter 25 may be arranged to project from the second side surface 32 (or be a projection of the second side surface 32) of the cavity 20 toward the cooking chamber 30. The second tray supporter 25 may be arranged to project inwardly from a sidewall of the cavity 20, and may form a depression from an outer side of the cavity 20 to an inner side.

At respective locations between the first tray retainer 22 and the first tray supporter 24 and between the second tray retainer 23 and the second tray supporter 25 opposing ends of the tray 200 may be supported and fixedly disposed inside the cooking chamber 30. Further details regarding the tray 200 will be described later.

FIG. 3 shows a cross-section of respective tray retainers and tray supporters, along a B-C plane. In an embodiment, the cross-sections may extend along the first direction A to define a length of the respective tray retainers and tray supporters along the first direction A. The length of the respective tray retainers and tray supporters along the first direction A may correspond to a entirety of a depth of the cavity 20 or the cooking chamber 30 along the first direction A, without being limited thereto. In an embodiment, a plurality of respective tray retainers and a plurality of corresponding tray supporters may be arranged spaced apart from each other along the first direction A. For example, a corresponding pair of a tray retainer and a tray supporter may be disposed corresponding to corners of the cavity 20 of the cooking chamber 30 which are defined along the A-B plane.

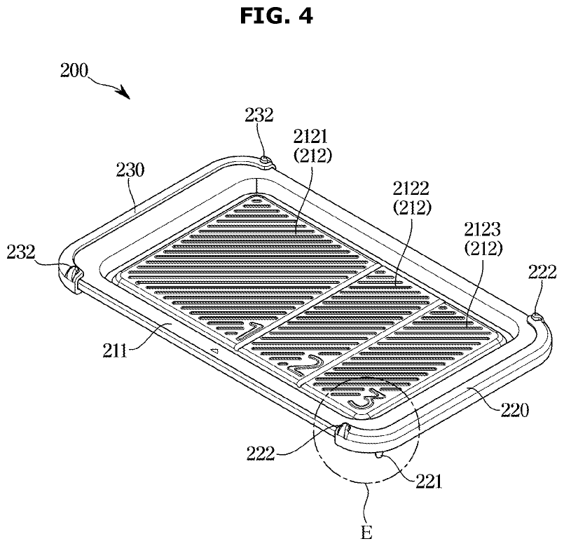

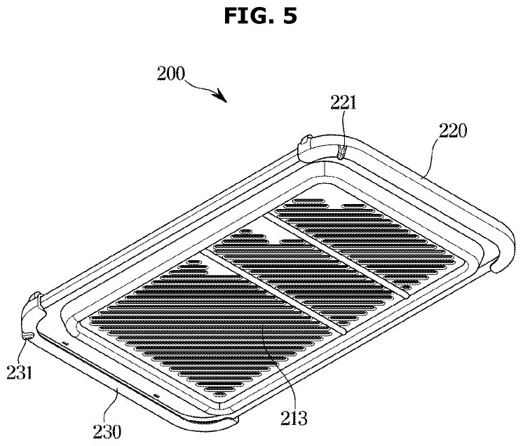

FIG. 4 is a top perspective view of a tray 200 of a cooking apparatus 1 according to an embodiment of the present invention. FIG. 5 is a bottom perspective view of the tray 200 of FIG. 4.

Referring to FIGS. 4 and 5, the tray 200 may include a plate 210 on which cooking is performed, and tray holders 220 and 230 as plate holders that support end portions of the plate 210.

The plate 210 may include an edge part 211 as an edge portion, and a cooking surface 212 as a main part or cooking part. In an embodiment, the edge portion may surround the main part (or the cooking surfaces), in a plan view (e.g., a view along the thickness direction).

The cooking surface 212 may include a plurality of cooking surfaces 2121, 2122 and 2123 on which cooking is performed.

The edge part 211 may be provided along a border of the cooking surface 212. The cooking surface 212 may be arranged to form a step with the edge part 211, such as to step down to a certain height along the third direction C from the inner side of the edge part 211. By doing so, when a cooking object is placed in the cooking surface 212, overflow of materials of the cooking object to the outside of the tray 200 or being dislodged from the tray 200 can be prevented.

The cooking surface 212 of the plate 210 may be provided with a plurality of cooking surfaces 2121, 2122 and 2123. A plurality of cooking surfaces 2121, 2122 and 2123 may include a first cooking surface 2121, a second cooking surface 2122, and a third cooking surface 2123. The first cooking surface 2121 may be provided at a location corresponding to the third cooking area 30c described above. The second cooking surface 2122 may be provided in a position corresponding to the second cooking area 30b, and the third cooking surface 2123 may be provided in a position corresponding to the first cooking area 30a.

Based on the center line G (see FIG. 3), the first cooking surface 2121 may be formed or provided at one side of the tray 200, and the second cooking surface 2122 together with the third cooking surface 2123 may be formed or provided at the opposite side of the tray 200.

The first cooking surface 2121 may be disposed at a position corresponding to the first heater 111 and the third heater 113 in the third direction C. The second cooking surface 2122 and the third cooking surface 2123 may be disposed at positions corresponding to the second heater 112 and the fourth heater 114 in the third direction C.

Since the heat transferred from the first heater 111 and the third heater 113 and from the second heater 112 and the fourth heater 114 are arranged differently, the temperature of the heat transferred to the first cooking surface 2121 and to the second cooking surface 2122 and the third cooking surface 2123, may be arranged differently.

Thus, it may be possible to place cooking objects having different cooking temperatures on the first cooking surface 2121, the second cooking surface 2122, and the third cooking surface 2123, and simultaneously cook each of the cooking objects in a single one of the cooking chamber 30.

Furthermore, different cooking objects can be positioned adjacent to each other along a left and right direction relative to a view from the first direction A as the front of the cooking apparatus 1, so that a cooking process of different cooking objects may be observed through the transparent part 41 in real time during operation of the cooking apparatus 1.

That is, the first cooking surface 2121, the second cooking surface 2122, and the third cooking surface 2123 may each be provided with different cooking temperatures along a single one of the tray 200.

The plate 210 may include a heat generator 213. The heat generator 213 may be formed on a lower surface of the plate 210. Through the heat generator 213, high frequencies generated from the magnetron 121 at the bottom may be absorbed by the tray 200, and the bottom side of a cooking object placed on the cooking surface 212 may be heated by the heat generated by the heat generator 213 of the tray 200.

The tray holders 220 and 230 may include a first tray holder 220 as a first plate holder and a second tray holder 230 as a second plate holder.

The first tray holder 220 may be mounted on one side of plate 210. The second tray holder 230 may be mounted on the other side of the plate 210 which is opposite to the one side.

The first tray holder 220 and the second tray holder 230 may be arranged to contact the first tray retainer 22 and the second tray retainer 23, respectively, described above. The first tray holder 220 and the second tray holder 230 may support both of the opposing ends of the plate 210 so that the plate 210 may be fixedly disposed inside the cooking chamber 30.

The first tray holder 220 may include a first interference member 221 formed forwardly. That is, the first interference member 221 may be provided closer to a front portion of the tray 200 than to a rear portion of the tray 200 along the first direction A. That is, the first interference member 221 may be disposed corresponding to a front side of the cooking chamber 30.

More specifically, the first interference member 221 may be arranged to project downwardly from the underside of the first tray holder 220, that is, in a direction opposite to the third direction C. The first interference member 221 may be arranged to not interfere with the first tray retainer 22 at the front side of the cooking chamber 30. The tray 200 which is mounted in the cooking chamber 30 includes the first interference member 221 covering or overlapping a forward (or front) portion of the first tray retainer 22.

The first interference member 221 may have a protruding shape which interferes with a shape of the second tray retainer 23, while not interfering with the first tray retainer 22. Details of this will be described later.

The second tray holder 230 may include a second interference member 231 formed forwardly. Since the second tray holder 230 and the first tray holder 220 are arranged in a shape symmetrical to each other, the second interference member 231 and the first interference member 221 may be arranged at a front side of the cooking apparatus 1, in positions symmetrical to each other with respect to the center line G.

The second interference member 231 may be arranged so as not to interfere with the second tray retainer 23. The tray 200 which is mounted in the cooking chamber 30 includes the second interference member 231 covering or overlapping a front portion of the second tray retainer 23.

The second interference member 231 may have a protruding shape which does not interfere with the second tray retainer 23, which interfering with the first tray retainer 22.

The first tray holder 220 may include a plurality of first separation members 222. A plurality of first separation members 222 may be formed at a front side and a rear side of the first tray holder 220, respectively. A plurality of first separation members 222 may be arranged to extend upwardly from a top surface of the first tray holder 220, that is, in the third direction C.

The second tray holder 230 may include a plurality of second separation members 232. A plurality of second separation members 232 may be formed at a front and a rear of the second tray holder 230, respectively. A plurality of second separation members 232 may be arranged to extend upwardly from a top surface of the second tray holder 230, that is, in the third direction C.

However, the number of the plurality of first separation members 222 and the number of the second separation members 232 may not be limited.

A plurality of first separation members 222 and a plurality of second separation members 232 may be arranged such that when the tray 200 is flipped upside down and placed on the bottom surface 34 inside the cooking chamber 30, the various separation members protrude toward the bottom surface 34 and define a gap between the bottom surface 34 and the cooking surface 212 of the tray 200. Further details in this regard will be described below.

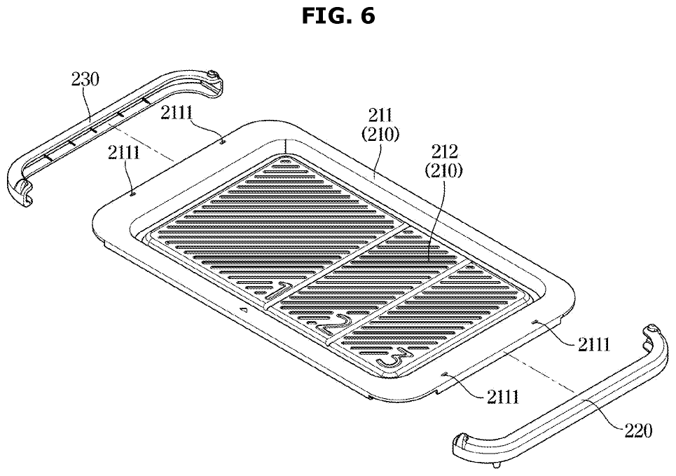

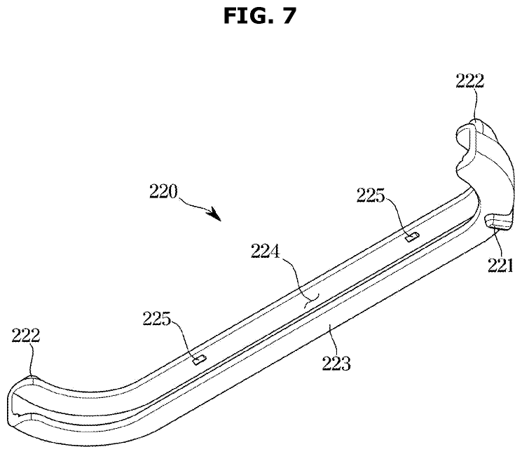

FIG. 6 is an exploded perspective view of the tray 200 of FIG. 4. FIG. 7 is a bottom perspective view of the tray holder 220 of FIG. 6.

Referring now to FIGS. 6 and 7, the first tray holder 220 and the second tray holder 230 may be mounted at opposing sides of the plate 210, respectively. More specifically, the tray holders may be mounted to cover the outer side of the edge part 211 of the plate 210, at the opposing ends.

The edge part 211 of the plate 210 may include a locking groove 2111 provided in plural for engagement with the first tray holder 220 and the second tray holder 230.

As shown in FIG. 7, the first tray holder 220 may include a locking protrusion 225 formed or provided on the inner upper surface of the tray holder 220.

The first tray holder 220 and the second tray holder 230 are arranged in a shape that is symmetrical to each other, and since the second tray holder 230 may also include the same configuration, a description of the detailed structure of the second tray holder 230 is omitted hereinafter.

The locking protrusion 225 may be provided as a hook-shaped protrusion extending downwardly from the inner upper surface of the first tray holder 220.

In FIGS. 6 and 7, the locking groove 2111 and the locking protrusion 225 are shown to be formed with two on each end of the tray 200, but the number is not limited.

The first tray holder 220 may have a plurality of plate portions connected to each other. The locking protrusion 225 may protrude from an inner side of a first plate portion, a second plate portion faces the first plate portion, and a side plate portion connects the first plate portion and the second plate portion to each other. The second plate portion may define a support surface 223 of the first tray holder 220 at which the first tray holder 220 is supported by the first tray retainer 22.

An accommodation space 224 may be formed on an inner side of the first tray holder 220. In an embodiment, the first to third plate portions define the accommodation space 224 which is open in a direction towards the plate 210. In the accommodation space 224 of the first tray holder 220, the edge part 211 of the plate 210 at one end thereof may be inserted. Thereby, the first tray holder 220 can more firmly support the edge part 211 of the plate 210 at the one end.

The first tray holder 220 and the second tray holder 230 may be made of a different material than the plate 210. More specifically, the first tray holder 220 and the second tray holder 230 may be arranged to include a resinous material.

It may be arranged that the cavity 20 as the inner housing forming the cooking chamber 30 includes a steel material, and the cooking surface 212 of the plate 210 also includes a steel material. In this case, if the plate 210 is mounted to be in contact with the cooking chamber 30, problems due to high frequencies may occur when the lower magnetron 121 is operated. Therefore, the first tray holder 220 and the second tray holder 230 can be respectively mounted at opposing ends of the plate 210 so that the first tray holder 220 and the second tray holder 230 are in contact with the cavity 20. This may reduce the probability of an accident or failure due to high frequency.

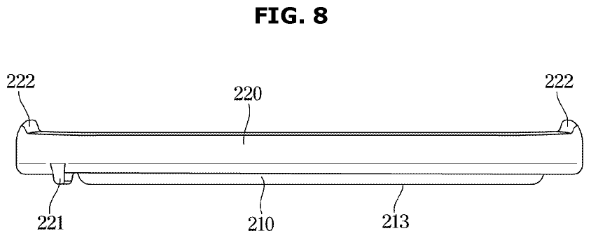

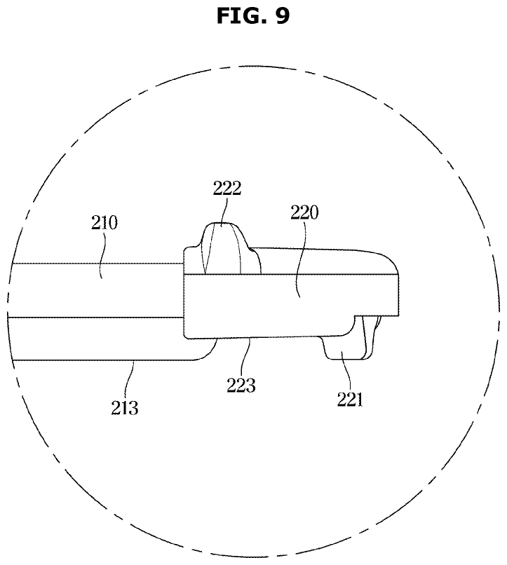

FIG. 8 is a side view of the tray 200 which includes the first tray holder 220 of FIG. 4 which is coupled to the plate 210. FIG. 9 is an enlarged front view of portion E of the tray of FIG. 4.

Referring to FIG. 8, the first interference member 221 may be formed only on the forward lower portion of the tray 200.

Insertion of the tray 200 into the cooking chamber 30 may include a rear side of the tray 200 facing the cooking chamber 30 along the first direction A, as opposed to the front side of the tray 200 where the first interference member 221 is formed facing the cooking chamber 30. This may be referred to as a forward insertion of the tray 200. That is, absence of the first interference member 221 at the leading side (e.g., the rear side) of the tray 200 which faces the cooking chamber 30 allows movement of the tray 200 along the first direction A such that the tray 200 cant proceed into the cooking chamber 30.

However, due to user error, there may exist a case where insertion of the tray 200 into the cooking chamber 30 includes the front side with the first interference member 221 facing the cooking chamber 30 along the first direction A. This may be referred to as reverse insertion of the tray 200.

In the reverse insertion, the first interference member 221 protruding at the front lower part of the tray 200 and the first tray retainer 22 protruding inwardly into the cooking chamber 30 may interfere with each other to prevent mis-insertion of the tray 200. That is, the first interference member 221 at the leading side (e.g., the front side) of the tray 200 may be aligned with the first tray retainer 22 along the first direction A such that movement of the tray 200 along the first direction A is restricted and the tray 200 cannot proceed into the cooking chamber 30.

Additionally, for either the forward insertion or the reverse insertion, the tray 200 disposes a plurality of first separation members 222 projected upwardly and opposite to the downward projection of the first interference member 221.

Along the second direction B, the plurality of first separation members 222 may be formed on an inner side of the tray 200 as compared to the first interference member 221, with respect to outer edges of the tray 200 along the second direction B (e.g., left-right direction in FIG. 3). More specifically, at an end of the tray 200 along the second direction B, a plurality of first separation members 222 may be further from the outer edge of the tray 200 than the first interference member 221. That is, the respective separation members and the first interference member 221 are disposed at different locations along the second direction B to corresponding to different lines extended along the first direction A.

Thus, the plurality of first separation members 222 corresponding to a first line extended along the first direction A can be arranged so that they do not interfere with each other and with the first tray supporter 24 formed on a same second line as the first tray retainer 22. Thus, forward insertion of the tray 200 may be facilitated.

A second interference member 231 and a plurality of second separation members 232 of the second tray holder 230 may also be arranged in the same structure and are therefore not described.

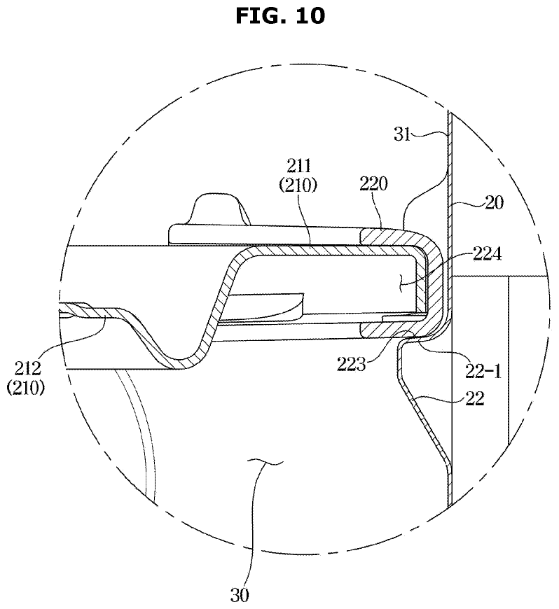

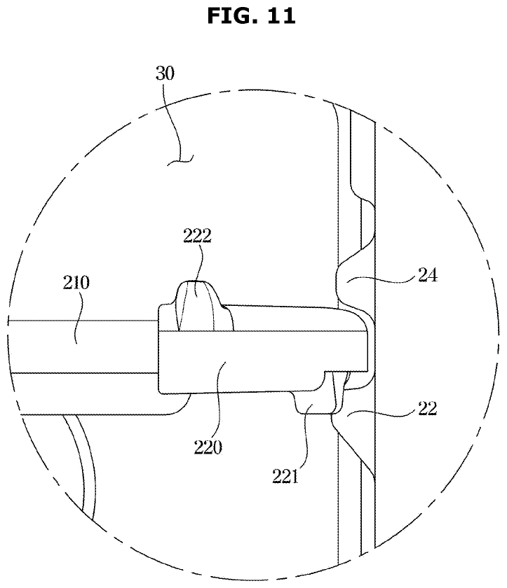

FIG. 10 is an enlarged view of portion F of FIG. 3. FIG. 11 is a front view of a tray 200 of a cooking apparatus 1 with the tray 200 seated in a tray retainer according to an embodiment of the present invention. FIG. 10 may be a cross-sectional view of the tray holder to show the relationship of features which engage with each other in coupling of the tray holder to the plate 210.

As shown in FIG. 10, the first tray holder 220 may be arranged to receive the edge portion 211 of the plate 210 within the accommodation space 224 of the first tray holder 220.

The first tray holder 220 may include a support surface 223 arranged to be supported on the first tray retainer 22. The first tray retainer 22 may include a holder fastening surface 22_1 at which the first tray holder 220 is secured to the cavity 20. The support surface 223 and the holder fastening surface 22_1 may be arranged to contact each other. Thereby, the first tray retainer 22 may support the first tray holder 220. As being in contact, elements may form an interface therebetween.

The second tray holder 230 and the second tray retainer 23 can also be arranged in the same structure and will not be described.

Referring to FIGS. 10 and 11, the first interference member 221 may be arranged to extend from the support surface 223 of the first tray holder 220 and further than the support surface 223, along the thickness direction. A distal end of the first interference member 221 may be lower than the holder fastening surface 22_1 of the first tray retainer 22. Thereby, the first interference member 221 may be arranged to cover or overlap a front portion of the first tray retainer 22.

Thus, when the front side of the tray 200 follows the rear side during insertion toward the cooking chamber 30 along the first direction A, the first tray retainer 22 and the first interference member 221 may collide or interfere with each other. More specifically, since the first interference member 221 extends to a position lower than the holder fastening surface 22_1 of the first tray retainer 22, the first interference member 221 and the front of the first tray retainer 22 may interfere with each other along the first direction A to restrict or stop movement of the tray 200 into the cooking chamber 30.

Since the tray 200 of the cooking apparatus 1 according to an embodiment of the present invention includes a plurality of cooking surfaces 2121, 2122 and 2123 that are cooked at different temperatures, if the tray 200 is misplaced by changing the left and right directions of the tray 200, the position of the cooking surface 212 may change and the cooking of the cooking object desired by the user may not be performed.

Therefore, to prevent such side-to-side mis-insertion of the tray 200, and the interference members 221 and 231 are formed only at the front side of the tray 200 and are omitted at the rear side of the tray 200.

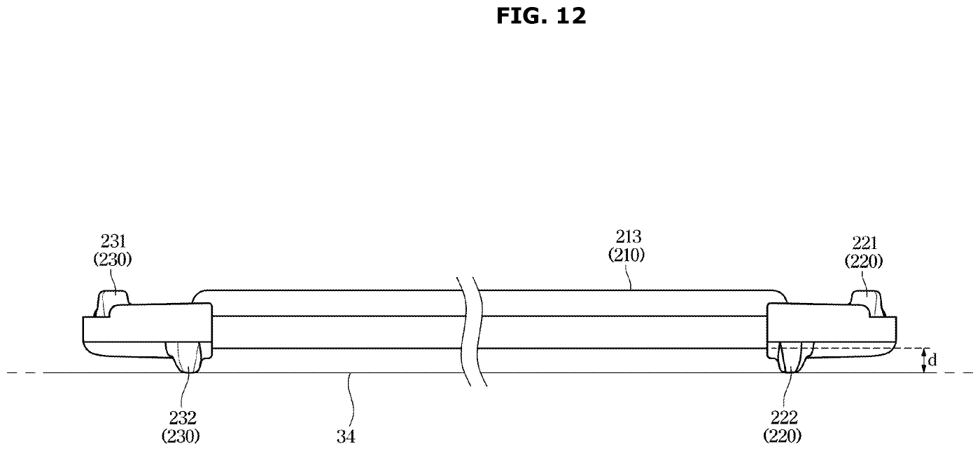

FIG. 12 illustrates the tray 200 of the cooking apparatus 1 lying face down on a bottom surface 34 according to an embodiment of the present invention.

As shown in FIG. 12, when the tray 200 is inverted and placed on the bottom surface 34 of the cooking chamber 30, a plurality of separation members may be arranged to be spaced apart by a certain distance ‘d’ between the top surface of the tray 200 which is facing the bottom surface 34, and the bottom surface 34.

In the case of the cooking apparatus 1 according to an embodiment of the present invention, the magnetron 121 that oscillates high frequencies is present at the bottom surface 34 (see FIG. 3). The lower surface of the tray 200 is provided with a material that absorbs these high frequencies (e.g., the heat generating layer), while the top surface of the tray 200 is provided with a surface that includes a cooking surface 212 on which a cooking object is placed and is generally provided with a steel material.

In this case, a spark may be formed between the bottom surface 34 of the cooking chamber 30 and the top surface of the tray 200 due to the high frequency generated by the magnetron 121, causing a safety accident or a failure of the device.

Thus, a plurality of separation members 222 and 232 may be arranged so that, even when the tray 200 is placed upside down and the cooking surface 212 is closer to the bottom surface 34 than the heat generating layer, the top surface and the lower surface of the tray 200 are spaced apart from each other so that high frequencies can escape to the outside without being trapped inside the tray 200.

In an embodiment, the separation distance ‘d’ may be approximately 8 mm or more. In other words, the extension height of each separation member among a plurality of separation members 222 and 232 with respect to the top surface of the plate 210 may be arranged to be 8 mm or more.

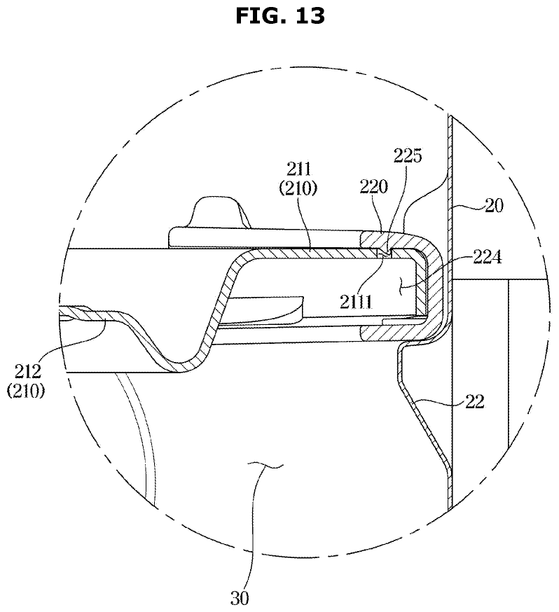

FIG. 13 illustrates the engagement of the plate 210 and the tray holder of the cooking apparatus 1 according to an embodiment of the present invention. FIG. 13 may be a cross-sectional view of the tray holder to show engagement of features which couple the tray holder to the plate 210.

As shown in FIG. 13, a locking protrusion 225 of the first tray holder 220 may be inserted into the locking groove 2111 formed in the edge part 211 of the plate 210. Although not shown separately, the second tray holder 230 may be provided with the same structure.

Accordingly, the first tray holder 220 and the plate 210 may be combined to each other in a hanging structure without a separate fastening member. As the magnetron 121 is disposed in the cooking apparatus 1 according to an embodiment of the present invention, problems due to high frequencies may occur. Therefore, as the plate 210 and the first tray holder 220 are formed as a frequency-jamming structure, various problems caused by high frequencies may be prevented.

Furthermore, the tray 200 of the cooking apparatus 1 according to one embodiment of the above-described invention may be an independent configuration that can be produced separately from the cooking apparatus 1.

The tray 200 may be an object used in the production of the cooking apparatus 1 of the present invention. Furthermore, the tray 200 may be an object used only for the production of the cooking apparatus 1 of the present invention. Thus, the tray 200 may be a configuration that fulfills both the requirements of public use and private use.

In other words, the tray 200 may be arranged exclusively for the cooking apparatus 1 of the present invention with no other use.

Thus, the results produced by utilizing the tray 200 can be attributed solely to the cooking apparatus 1 of the present invention.

Therefore, the tray 200 of the cooking apparatus 1 according to an embodiment of the present invention may be subject to indirect infringement as a dedicated article.

In an embodiment, a cooking apparatus 1 includes a housing (e.g., the housing and/or the cavity 20) defining a cooking chamber 30, a tray retainer 22 protruded from a side of the housing and toward the cooking chamber 30, a cooking tray (e.g., the tray 200) which is insertable into the cooking chamber 30 and detachably engageable with the housing at the tray retainer 22, the cooking tray including a plurality of cooking surfaces (e.g., at the cooking surface 212 such as the first, second and third cooking surfaces 2121, 2122 and 2123) defined at a first surface of the cooking tray, and an interference member such as the first interference member 221 protruding from a second surface of the cooking tray which is opposite to the first surface, and a plurality of heaters (e.g., the first heating source 110) which provide heats of different temperatures to the plurality of cooking surfaces of the cooking tray.

In an embodiment, a cooking apparatus includes a housing defining a cooking chamber 30, a tray retainer 22 protruded from a side of the housing and toward the cooking chamber 30, a cooking tray which is insertable into the cooking chamber 30 in an insertion direction (e.g., a direction opposite to the first direction A indicated in FIG. 2, for example) and detachably engageable with the housing at the tray retainer 22, the cooking tray includes a plurality of cooking surfaces defined at a first surface of the cooking tray, a rear side (e.g., right side in FIG. 8) and a front side (e.g., left side in FIG. 8) which is opposite to the rear side along the insertion direction, and an interference member protruding from a second surface of the cooking tray which is opposite to the first surface, the interference member protruding only at the front side of the cooking tray, and a plurality of heaters (e.g., the heating sources 100) which respectively provide heats to the first surface and to the second surface of the cooking tray. The cooking tray is insertable into the cooking chamber in a front insertion of the cooking tray, the front insertion including the rear side of the cooking tray leading the front side of the cooking tray in the insertion direction, together with the interference member contacting the tray retainer along the insertion direction (see FIGS. 2 and 3 together with FIG. 11, for example). The cooking tray is non-insertable into the cooking chamber in a reverse insertion of the cooking tray, the reverse insertion including the front side of the cooking tray leading the rear side of the cooking tray in the insertion direction, together with the interference member interfering with the tray retainer along the insertion direction, where interference between the tray retainer and the interference member blocks insertion of the cooking tray into the cooking chamber.

The cooking tray may further include a plate 210 defining the plurality of cooking surfaces, the plate including an edge portion (e.g., the edge part 211) adjacent to the plurality of cooking surfaces, and a tray holder such as the first tray holder 220 removably mountable to the plate at the edge portion of the plate (see FIG. 6) The cooking tray which is inserted into the cooking chamber includes the tray holder engaged with the tray retainer (see FIGS. 3, 10 and 11, for example).

The tray holder may include a support surface 223, and the interference member protruded from the support surface 223. The tray retainer may include a holder fastening surface 22_1 and front insertion of the cooking tray includes the support surface 223 of the tray holder engaged with the holder fastening surface 22_1 of the tray retainer 22, in the cooking chamber 30.

The interference member of the cooking tray may extend from the support surface 223, and the front insertion of the cooking tray may further include the interference member extended further than the holder fastening surface 22_1 of the tray retainer 22.

The edge portion of the plate 210 may define a locking groove 2111, and the tray holder which is mounted to the plate 210 includes the tray holder engaged with the locking groove 2111 of the plate 210. The tray holder which is mounted to the plate may include a locking protrusion 225 of the tray holder engaged with the locking groove 2111 of the plate 210.

A tray supporter may be protruded from the side of the housing and face the tray retainer, the tray supporter being closer to the plurality of heaters 110 than the tray retainer. The cooking tray which is inserted into the cooking chamber 30 may include includes a portion of the cooking tray between the tray supporter and the tray retainer, together with the tray supporter restricting movement of the cooking tray away from the tray retainer and towards the plurality of heaters 110.

The first surface of the cooking tray may include an upper surface of the tray holder, and the plurality of separation members may protrude from the upper surface of the tray holder. The first surface of the cooking tray may further include an upper surface of the plate, and a height of the plurality of separation members with respect to the upper surface of the plate may be approximately 8 millimeters or more.

Within the cooking tray, the plurality of cooking surfaces are adjacent to each other along a length direction of the cooking tray (e.g., along the second direction B), opposing ends of the cooking tray are defined along the length direction, the interference member corresponding to an end of the cooking tray among the opposing ends (see FIGS. 4 and 5, for example), and the plurality of separation members are each further from the end of the cooking tray than the interference member, along the length direction (see FIG. 9 where second separation member 222 is further from the right end of the tray 200 than the first interference member 221).

The cooking apparatus 1 may further include a magnetron which generates frequencies. The cooking chamber 30 may include a bottom surface 34, within the cooking chamber 30, the magnetron may be closer to the bottom surface 34 than the plurality of heaters, and the cooking tray may further include a heat generating layer (e.g., the heat generator 213) which absorbs the frequencies generated by the magnetron, the heat generating layer extended along the second surface of the cooking tray.

The cooking tray may be removably mountable on the bottom surface 34 of the cooking chamber 30. The cooking tray which is mounted on the bottom surface 34 of the cooking chamber may include the plurality of separation members protruded towards the bottom surface 34 together with the interference member protruded in a direction away from the bottom surface 34. The bottom surface 34 of the cooking chamber may be defined by a glass member 80 between the magnetron and the plurality of heaters.

The cooking tray may further include a heat generating layer (e.g., the heat generator 213) which absorbs the frequencies generated by the magnetron, the heat generating layer extended along the second surface of the cooking tray. The cooking tray which is inserted into the cooking chamber 30 includes the first surface of the cooking tray facing the plurality of heaters together with the second surface facing the magnetron.

The cooking tray which is inserted into the cooking chamber 30 may define an upper portion of the cooking chamber 30 between the cooking tray and the plurality of heaters (e.g., at cooking areas 30a, 30b and 30c), together with a lower portion of the cooking chamber 30 between the cooking tray and the magnetron (e.g., at cooking area 30d). The upper portion and the lower portion of the cooking chamber 30 may be heated simultaneously with each other, by respective heaters.

Specific embodiments have been shown and described above. However, the invention is not limited to the above embodiments, and one having ordinary skill in the art to which the invention belongs will be able to make various modifications without departing from the spirit of the technical idea of the invention set forth in the following claims.

What is claimed is:

1. A cooking apparatus comprising:
a housing defining a cooking chamber;
a tray retainer protruded from a side of the housing and toward the cooking chamber;
a cooking tray which is insertable into the cooking chamber and detachably engageable with the housing at the tray retainer, the cooking tray comprising:
a plurality of cooking surfaces defined at a first surface of the cooking tray, and
an interference member protruding from a second surface of the cooking tray which is opposite to the first surface; and
a plurality of heaters which provide heats of different temperatures to the plurality of cooking surfaces of the cooking tray.

2. The cooking apparatus of claim 1, wherein
the cooking tray is insertable into the cooking chamber in an insertion direction;
the cooking tray further comprises a rear side and a front side which is opposite to the rear side along the insertion direction, the interference member being at the front side of the cooking tray; and
the cooking tray which is inserted into the cooking chamber includes the cooking tray engaged with the tray retainer, together with the interference member covering a portion of a front of the tray retainer.

3. The cooking apparatus of claim 1, wherein
the cooking tray further comprises:
a plate defining the plurality of cooking surfaces, the plate comprising an edge portion adjacent to the plurality of cooking surfaces; and
a tray holder removably mountable to the plate at the edge portion of the plate; and
the cooking tray which is inserted into the cooking chamber includes the tray holder engaged with the tray retainer.

4. The cooking apparatus of claim 3, wherein
the tray holder comprises:
a support surface; and
the interference member protruded from the support surface;
the tray retainer comprises a holder fastening surface; and
front insertion of the cooking tray includes the support surface of the tray holder engaged with the holder fastening surface of the tray retainer, in the cooking chamber.

5. The cooking apparatus of claim 4, wherein
the interference member of the cooking tray extends from the support surface; and
the front insertion of the cooking tray further includes the interference member extended further than the holder fastening surface of the tray retainer.

6. The cooking apparatus of claim 1, wherein
the cooking tray is insertable into the cooking chamber in an insertion direction;
the cooking tray further comprises a rear side and a front side which is opposite to the rear side along the insertion direction, the interference member being at the front side of the cooking tray; and
reverse insertion of the cooking tray includes the front side of the cooking tray leading the rear side of the cooking tray in the insertion direction, together with the interference member interfering with the tray retainer along the insertion direction to block further insertion of the cooking tray into the cooking chamber.

7. The cooking apparatus of claim 3, wherein
the edge portion of the plate defines a locking groove; and
the tray holder which is mounted to the plate includes the tray holder engaged with the locking groove of the plate.

8. The cooking apparatus of claim 7, wherein
the tray holder comprises a locking protrusion; and
the tray holder which is mounted to the plate includes the locking protrusion of the tray holder engaged with the locking groove of the plate.

9. The cooking apparatus of claim 3, wherein within the cooking tray, the tray holder comprises a material different from a material of the plate.

10. The cooking apparatus of claim 1, further comprising a tray supporter which is protruded from the side of the housing and faces the tray retainer, the tray supporter being closer to the plurality of heaters than the tray retainer,
wherein the cooking tray which is inserted into the cooking chamber includes a portion of the cooking tray between the tray supporter and the tray retainer, together with the tray supporter restricting movement of the cooking tray away from the tray retainer and towards the plurality of heaters.

11. The cooking apparatus of claim 1, wherein the cooking tray further comprises a plurality of separation members protruding from the first surface of the cooking tray.

12. The cooking apparatus of claim 11, wherein the cooking tray further comprises:
a plate defining the plurality of cooking surfaces, the plate comprising an edge portion adjacent to the plurality of cooking surfaces;
a tray holder removably mountable to the plate at the edge portion of the plate;
the first surface of the cooking tray including an upper surface of the tray holder; and
the plurality of separation members protruding from the upper surface of the tray holder.

13. The cooking apparatus of claim 12, wherein
the first surface of the cooking tray further including an upper surface of the plate; and
a height of the plurality of separation members with respect to the upper surface of the plate is approximately 8 millimeters or more.

14. The cooking apparatus of claim 11, wherein within the cooking tray:
the plurality of cooking surfaces are adjacent to each other along a length direction of the cooking tray;
opposing ends of the cooking tray are defined along the length direction, the interference member corresponding to an end of the cooking tray among the opposing ends; and
the plurality of separation members are each further from the end of the cooking tray than the interference member, along the length direction.

15. The cooking apparatus of claim 11, further comprising a magnetron which generates frequencies,
wherein
the cooking chamber includes a bottom surface;
within the cooking chamber, the magnetron is closer to the bottom surface than the plurality of heaters; and
the cooking tray further comprises a heat generating layer which absorbs the frequencies generated by the magnetron, the heat generating layer extended along the second surface of the cooking tray.

16. The cooking apparatus of claim 15, wherein
the cooking tray is removably mountable on the bottom surface of the cooking chamber; and
the cooking tray which is mounted on the bottom surface of the cooking chamber includes the plurality of separation members protruded towards the bottom surface together with the interference member protruded in a direction away from the bottom surface.

17. The cooking apparatus of claim 15, wherein the bottom surface of the cooking chamber is defined by a glass member between the magnetron and the plurality of heaters.

18. The cooking apparatus of claim 11, further comprising a magnetron which generates frequencies,
wherein
the cooking tray further comprises a heat generating layer which absorbs the frequencies generated by the magnetron, the heat generating layer extended along the second surface of the cooking tray; and
the cooking tray which is inserted into the cooking chamber includes the first surface of the cooking tray facing the plurality of heaters together with the second surface facing the magnetron.

19. The cooking apparatus of claim 18, wherein
the cooking tray which is inserted into the cooking chamber defines an upper portion of the cooking chamber between the cooking tray and the plurality of heaters, together with a lower portion of the cooking chamber between the cooking tray and the magnetron; and
the upper portion and the lower portion of the cooking chamber are heated simultaneously with each other.

20. A cooking apparatus comprising:
a housing defining a cooking chamber;
a tray retainer protruded from a side of the housing and toward the cooking chamber;
a cooking tray which is insertable into the cooking chamber in an insertion direction and detachably engageable with the housing at the tray retainer, the cooking tray comprising:
a plurality of cooking surfaces defined at a first surface of the cooking tray,
a rear side and a front side which is opposite to the rear side along the insertion direction; and
an interference member protruding from a second surface of the cooking tray which is opposite to the first surface, the interference member protruding only at the front side of the cooking tray; and
a plurality of heaters which respectively provide heats to the first surface and to the second surface of the cooking tray,
wherein
the cooking tray is insertable into the cooking chamber in a front insertion of the cooking tray, the front insertion including the rear side of the cooking tray leading the front side of the cooking tray in the insertion direction, together with the interference member contacting the tray retainer along the insertion direction; and
the cooking tray is non-insertable into the cooking chamber in a reverse insertion of the cooking tray, the reverse insertion including the front side of the cooking tray leading the rear side of the cooking tray in the insertion direction, together with the interference member interfering with the tray retainer along the insertion direction, wherein interference between the tray retainer and the interference member blocks insertion of the cooking tray into the cooking chamber.
